(19) United States
(12) Patent Application Publication
(10) Pub. No.: US 2007/0129056 A1
(43) Pub. Date: Jun. 7, 2007

(54) MOBILE PHONE AGE VERIFICATION SYSTEM AND METHOD FOR AGE-RESTRICTED PROMOTIONS

(75) Inventors: Russel Cheng, Tokyo (JP); Christopher J. Phelan, Tokyo (JP); Neil Van Wouw, Tokyo (JP); Mark Van Wouw, Kanagawa (JP)

Correspondence Address: SQUIRE, SANDERS & DEMPSEY L.L.P, PATENT DEPARTMENT, ONE MARITIME PLAZA, SUITE 300, SAN FRANCISCO, CA, 94111-3492, US

(73) Assignee: BEACON COMMUNICATIONS KK, Tokyo (JP)

(21) Appl. No.: 11/164,772

(22) Filed: Dec. 5, 2005

(51) Int. Cl. H04M 11/00

(52) U.S. Cl. 455/405; 455/418

(57) ABSTRACT

A computer enables speedier access to age-restricted promotions by receiving registration data and an image of a photo ID from an applicant's mobile phone, thereby enabling an operator or the computer to verify that the applicant meets the age requirement. Once verified, the computer sends a URL to the mobile phone for accessing the promotion.

### TECHNICAL FIELD

This invention relates generally to age verification, and more particulary, but not exclusively, provides a system and method of using a mobile phone to verify age of an applicant for an age-restricted promotion.

### BACKGROUND

The sale of certain products can be restricted based on age. For example, the sale or distribution (hereinafter, referred to collectively as distribution) of tobacco and alcohol are restricted to people aged at least 18 and 21, respectively, in most U.S. jurisdictions. Accordingly, in order to avoid violation of the law, it is necessary for a seller or distributor (hereinafter, referred to collectively as a distributor) of age-restricted products to verify the age of a person trying to obtain the product. Therefore, it is also important not to promote products to people who do not meet age requirements (hereinafter referred to as underage persons) because it may be illegal in some jurisdiction to promote the product to underage persons; the underage persons cannot legally purchase the product, thereby leading to wasted resources on the promotion; and promotions to underage persons may generate bad publicity for the promoter.

Therefore, a new system and method are needed that enable speedy access to age restricted promotions.

### SUMMARY

Embodiments of the invention provide a system and method that enable speedier access (e.g., about 10 minutes) to age-restricted promotions by receiving registration data and an image of a photo ID from an applicant's mobile phone, thereby enabling an operator or the computer to verify that the applicant meets the age requirement. Once verified, the computer sends a URL to the mobile phone for accessing the promotion.

In one embodiment, the method comprises: receiving registration data and an image of an ID from a mobile device of an applicant for an age-restricted promotion; verifying that the applicant meets an age requirement; and granting access to the promotion if the applicant meets the age requirement.

In an embodiment of the invention, the system comprises: a registration engine, an age engine, a photo engine, and a promotion engine. The registration engine receives registration data and from a mobile device of an applicant for an age-restricted promotion. The photo engine receives an image of an ID from the mobile device. The age engine verifies that the applicant meets an age requirement. The promotion engine, which is communicatively coupled to the age engine, grants access to the promotion if the applicant meets the age requirement.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a diagram illustrating a system according to an embodiment of the invention;

FIG. 2 is a block diagram illustrating a server of the system of FIG. 1;

FIG. 3 is a block diagram illustrating a persistent memory of the server of FIG. 2;

FIG. 4 is a block diagram illustrating a database of the persistent memory of FIG. 3; and

FIG. 5-FIG. 7 are flowcharts illustrating a method of accessing an age-restricted promotion.

### DETAILED DESCRIPTION OF THE ILLUSTRATED EMBODIMENTS

The following description is provided to enable any person having ordinary skill in the art to make and use the invention, and is provided in the context of a particular application and its requirements. Various modifications to the embodiments will be readily apparent to those skilled in the art, and the principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

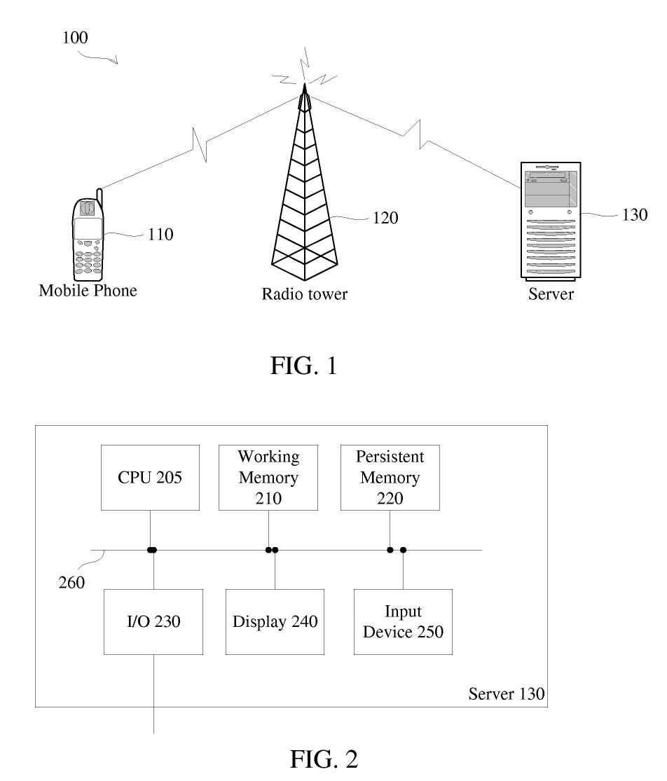

FIG. 1 is a diagram illustrating a system 100 according to an embodiment of the invention. The system 100 registers applicants via a secure online application form; verifies age of the applicant with a photo of the applicant's driver's license; and establishes a personalized channel for two way communication via the email on a mobile phone. The system 100 comprises a mobile phone 110 communicatively coupled to a server 130 via a radio tower 120. In an embodiment of the invention, the mobile phone 110 is wirelessly coupled to the radio tower 120, which is wire coupled to the server 130, either directly or via a network, such as the Internet. In an embodiment of the invention, the system 100 can include any device capable of communicating with the server 130 instead of the mobile phone 110. The system 100 can also include additional components, such as a load balancer and a firewall. Further, the server 130 can comprise a plurality of servers, including a web server, mail server and database server but is illustrated as a single server for ease of illustration.

To start the application process, an applicant sends a blank email or other communication with the mobile phone 100 to the server 130 using his or her mobile phone's email application or other application. This establishes the initial contact and links the applicant to the server 130 via the applicant's unique mobile phone's email address or other identifier.

When the server 130 receives the applicant's blank email, the server 130 automatically sends an email greeting with information about the promotion, instructions on how to apply and a unique time-sensitive URL with the applicant's unique mobile phone email address (or other identifier) embedded in it to the applicant's mobile phone 110. The embedded email address is a security feature that prevents another person's mobile phone or PC from using the unique URL to access the system.

The server 130 checks to see if the mobile phone email address is already in a registration database. If it is unique, the server 130 creates a new record and stores the applicant's email address in a temporary database to continue the transaction. The server 130 then creates a unique URL with the applicant's mobile phone email address, establishes the email address as the unique key, creates a status field to indicate registration process progress and creates a timestamp field to limit the time a customer has to complete the registration. Email addresses already in the registration database are sent an email error message that he is already registered.

The applicant receives and reads his email on his mobile phone email application. In his email application, the applicant clicks on the unique time-sensitive URL. This action automatically launches his mobile phone's web browser and connects to the URL.

The applicant reads and understands the instructions and begins to fill in the application (registration) form. The form's required personal data includes last name, first name, postal code, address, date of birth, etc. The applicant also chooses his own user ID and password. The application form may also include an opt-in statement for future promotional materials, and over age requirement checkbox, marketing questions, and a product ID (e.g., a barcode of a cigarette pack) if a product purchase is required for the promotion.

Upon clicking on a submit button, the server 130 does a series of input validations on the registration form and displays the appropriate error message if necessary and the applicant is required to correctly format the input. For example, one validation point may be only numerals are allowed in a mobile phone number field.

Upon successfully submitting the form to the server 130, the applicant is requested via a handset dialog box to provide his mobile phone's unique handset ID number (similar to unique serial number of the mobile phone) into the system. Users that say “yes” have their handset ID numbers automatically and transparently sent into the system. A “yes” enables the applicant to streamline his subsequent access to the server 130 after his registration is approved. The unique handset ID provides the server 130 with one additional bit of data that connects the applicant's mobile phone email address to the applicant's mobile phone 110 (mobile phone to email address to unique handset ID).

The server 130 matches the unique URL with the applicant's mobile phone email address and parses the personal data into database fields. The server 130 also appends the unique handset ID into the appropriate database field. The server 130 then sends an email acknowledgment to the applicant's mobile phone 110 with receipt of his application form with instructions for the next steps to take.

The applicant receives an email from the server 130 acknowledging the receipt of his application form with instructions for the applicant to take a photo of his valid driver's license with his mobile phone camera and send it back to the system as an email attachment. An email address for photo validation is provided to the applicant to submit his email photo attachment of his driver's license.

The server 130 receives the applicant's mobile email with photo attachment. The server 130 links up the email with an existing unique email address and makes a match. If there is not a match, the applicant is sent an error message to register first before sending in a photo of his driver's license. The server 130 checks if the email has an attachment. If there is no attachment, the server 130 sends an error message to attach a photo of his driver's license. The server 130 checks the status of the applicant's photo submission (is it a pending photo or a re-sent photo). Applicants with pending photos receive an acknowledgement that their photo was received and need to wait for approval. Applicants with re-sent photos that are approved are sent a registration is approved email to his mobile phone 110. An operator manually reviews the applicant's form data with his driver's license photo. Alternatively, the server 130 can verify the license data and/or form data as discussed in further detail below. The operator verifies that the applicant meets the age requirement for this particular promotion. Successful applicants receive an access URL to the promotion. Data is now recorded to the registration database. Unsuccessful applicants receive appropriate instructions to proceed or are rejected by the operator.

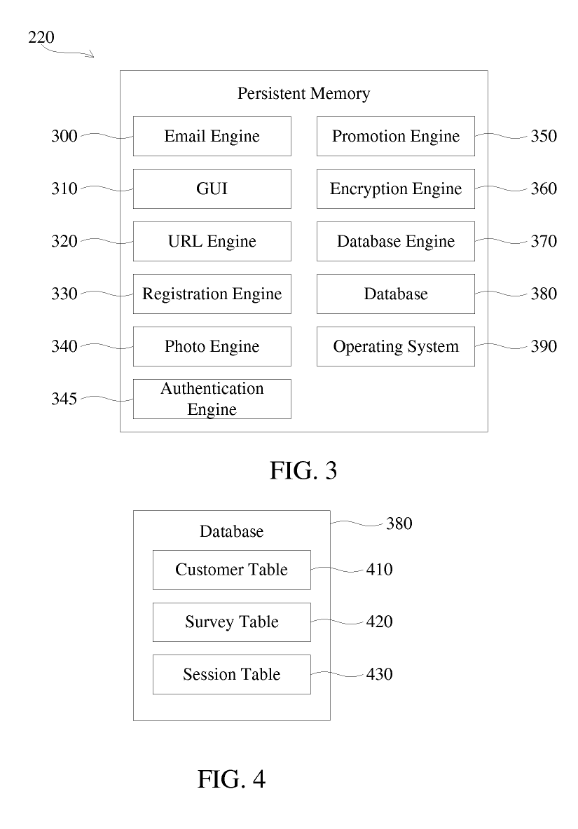

FIG. 2 is a block diagram illustrating the server 130. The server 130 includes a central processing unit (CPU) 205; working memory 210; persistent memory 220; input/output (I/O) interface 230; display 240; and an input device 250; all communicatively coupled to each other via a bus 260. The CPU 205 may include an Intel Pentium microprocessor, or any other processor capable to execute software stored in the persistent memory 220. The working memory 210 may include random access memory (RAM) or any other type of read/write memory devices or combination of memory devices. The persistent memory 220 may include a hard drive, read only memory (ROM) or any other type of memory device or combination of memory devices that can retain data after the computer 200 is shut off. The I/O interface 230 can be communicatively coupled, via wired or wireless techniques, directly, or indirectly, to the mobile phone 110. The display 240 may include a flat panel display, cathode ray tube display, or any other display device. The input device 250, which is optional like other components of the invention, may include a keyboard, mouse, or other device for inputting data, or a combination of devices for inputting data.

One skilled in the art will recognize that the server 130 may also include additional devices, such as network connections, additional memory, additional processors, LANs, input/output lines for transferring information across a hardware channel, the Internet or an intranet, etc. One skilled in the art will also recognize that the programs and data may be received by and stored in the system in alternative ways.

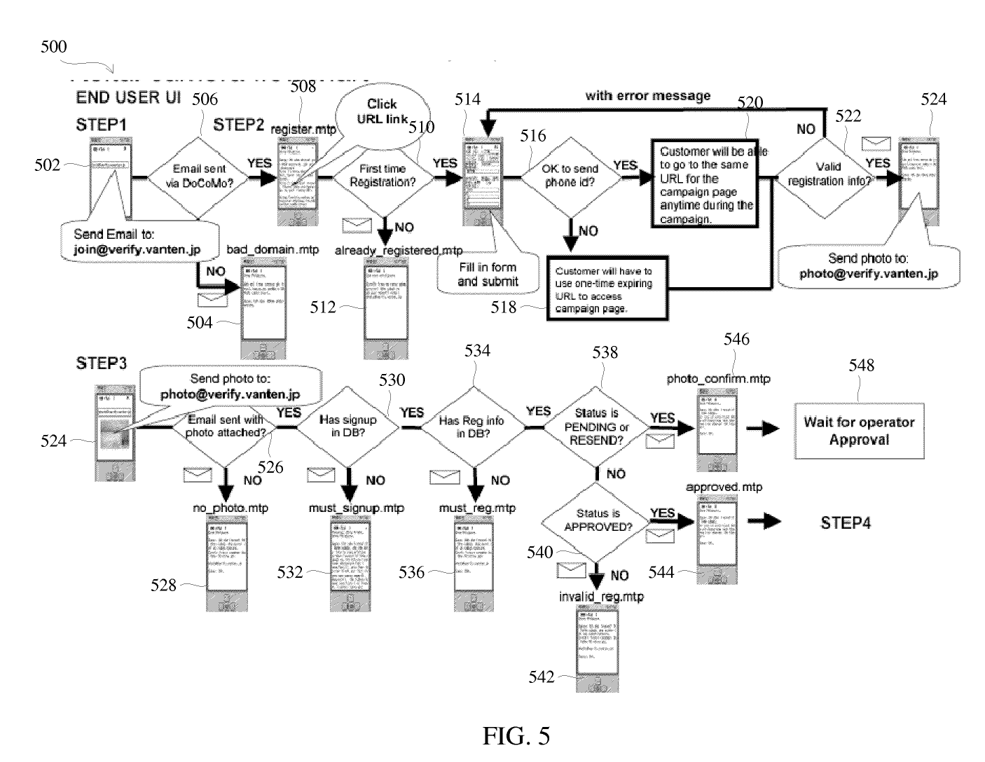

FIG. 3 is a block diagram illustrating a persistent memory 220 of the server 130. The memory 220 includes an email engine 300; a graphical user interface (GUI) 310; a URL engine 320; a registration engine 330; a photo engine 340; an authentication engine 345; a promotion engine 350; an encryption engine 360; a database engine 370; a database 380; and an operating system 390.

The email engine 300 transmits and receives emails to/from the mobile phone 110, such as the blank email from the mobile phone 110 to initiate the registration process and the welcome email that includes information about the registration process. The GUI 310 provides a user interface to an operator of the server 130 as well as for the registration form to register for the promotion. The URL engine 320 generates URLs that the email engine 300 transmits to the mobile phone 110, such as the time sensitive URL that includes a mobile phone identifier (e.g., mobile phone email address) for use in accessing the registration page.

The registration engine 330, in conjunction with the GUI 310, presents a registration form to the applicant and accepts data from the registration form. Further, the registration engine 330 causes the database engine 370 to add the registration data to the database 380, such as email address, a timestamp, name, address, mobile phone number, date of birth, license or other ID photo, user ID, password, etc. The registration engine 330 also validates the registration data (e.g., checks if the name does not contain numerals). The registration engine 330 further checks if an applicant has already tried to register or is registered so that the applicant does not repeat the registration process.

The photo engine 340 receives photos of IDs, such as driver licenses, as email attachments and separates the photos for processing. In another embodiment of the invention, the photo engine 340 also receives photos of applicants so that the authentication engine 345 can run facial recognition software to compare the applicant photo with the ID photo for verification.

The authentication engine 345 authenticates the ID and/or authenticates that the applicant matches the ID. In one embodiment, the authentication engine 345 uses facial recognition software to match the ID photo with a photo of the applicant. Alternatively, an operator of the server 130 can manually perform the match. In another embodiment of the invention, the authentication engine 345 uses optical character recognition (OCR) software to read the ID photo and verify that the data entered by the applicant in the registration form matches the data from the ID.

In another embodiment, the authentication engine 335 authenticates the ID to confirm it is authentic by looking for the presence and placement of features for that type of ID. The authentication engine 335 can also contact a remote database (e.g., a government database) to confirm the authenticity of the ID (e.g., that the ID holder does in fact have an ID issued by the government authority and that the data on the ID matches the data in the government database). In another embodiment, the authentication engine 335 confirms that the ID matches the expected appearance of an official ID (e.g., correct location of photograph, font text, size and placement, ink color and color densities, etc.).

In an embodiment of the invention, the memory 220 includes an age engine (not shown) that determines if the applicant meets a minimum age by calculating the age based the day's date and the ID holder's birth date. The ID holder's birth date is determined by data entered by the applicant in the registration form or by OCR of the ID. If the age exceeds the minimum required age for the product being distributed, then the age engine enables the other engines, such as the database engine 370 to store data, the registration engine 330 to proceed with registration and to provide access to the promotion engine 350.

The promotion engine 350 provides promotional material to an applicant once successfully registered, such as a video, a mobile phone game, a recorded call from a celebrity, etc.

The encryption engine 360 encrypts some or all data stored in the database 380 and decrypts the data for viewing on the display 240. Encrypting the data ensures unauthorized users cannot view the data in case of the loss of the server 130 or other unauthorized access. The database engine 370 stores data in the database 380 and retrieves data from the database 380. Data stored can include: date and time of when the registration process started; original scanned copy of the ID in TIFF or other format; OCR converted text with edits, including last name, first name, prefecture (state), address field 1, address field 2 and date of birth; additional required data fields such as postal code, mobile phone email address, user ID, user password and digital signature; optional data fields such as sex, occupation, bar codes and marketing questions; and date and time of when data is recorded (e.g., when the registration process is ended).

The operating system (OS) 390 can include Windows XP or other operating system (e.g., Mac OS).

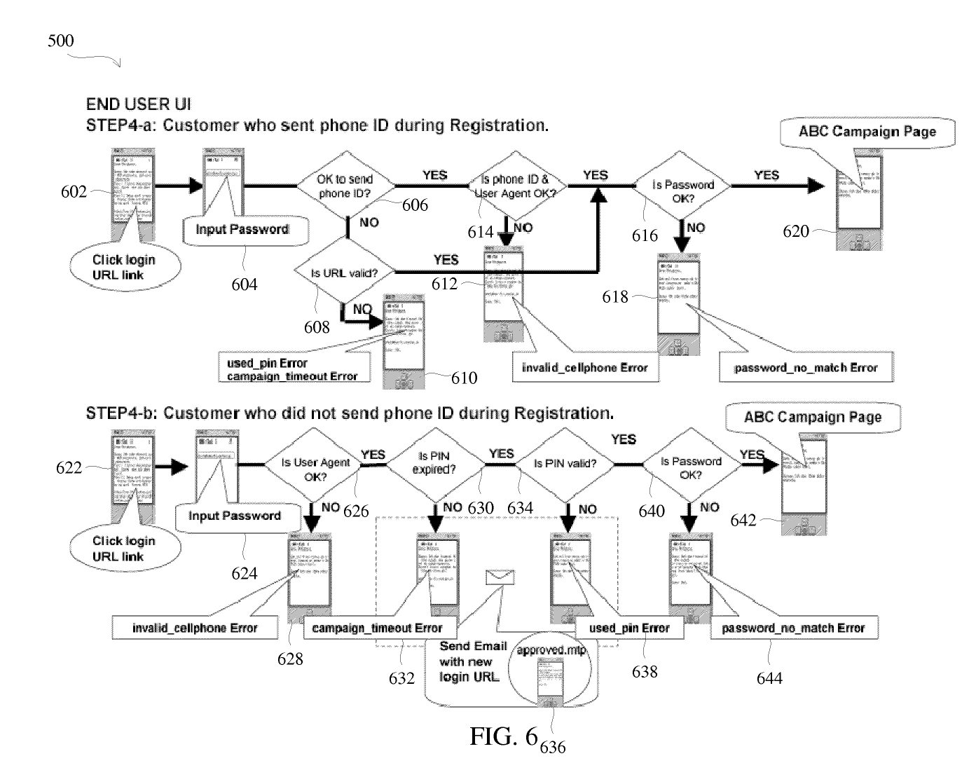

FIG. 4 is a block diagram illustrating the database 380. The database 380 comprises a customer table 410, a survey table 420 and a session table 430. In embodiment of the invention, data can be stored in other formats besides tables, such as linked lists, etc. The customer table 410 stores applicants' personal information (address, etc.) and can use an email address as a unique key. The customer table 410 can include an image of the ID, a login ID and password, and a status field to indicate and registration process progress. The survey table 420 includes applicant marketing questions results into the customer table 410. The session table 420 includes one time PINs, timestamps for aging PINs, and session state information into the customer table 410.

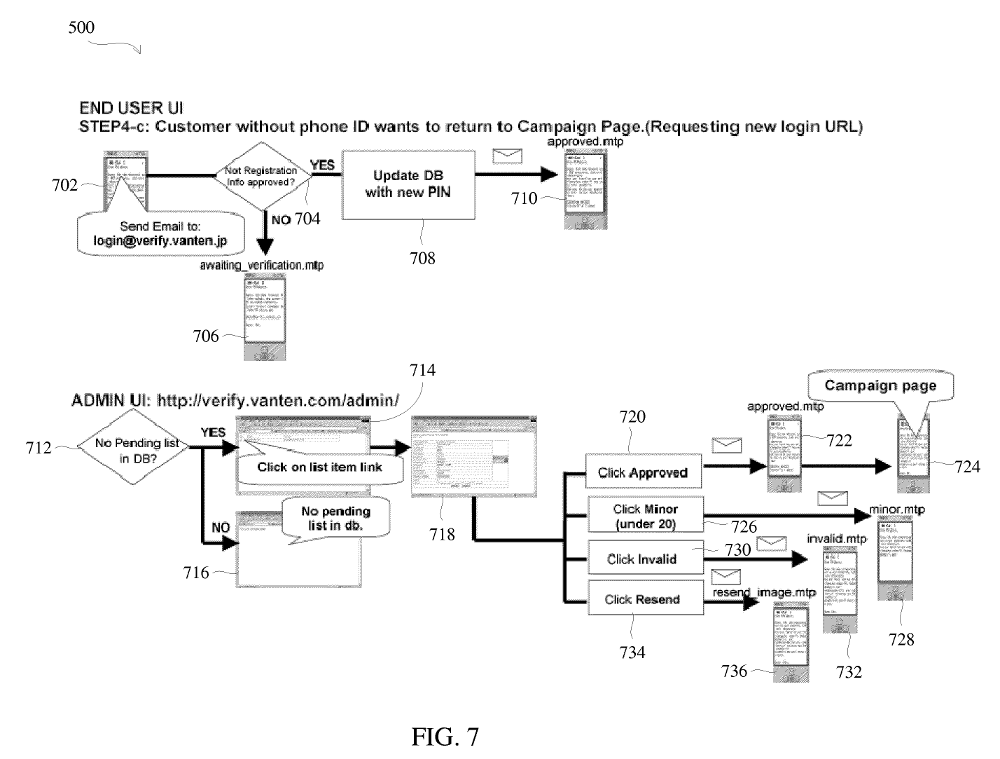

FIG. 5-FIG. 7 are flowcharts illustrating a method of accessing an age-restricted promotion. First, an applicant sends (502) a blank email to a promotion email address. If it is not sent (506) through an approved service, such as DoCoMo in Japan, the applicant receives (504) a notice indicating a bad domain or other error. Otherwise, the applicant receives (508) a registration email with a unique URL including the applicant's phone email address or other phone identifier. The applicant clicks on the URL to receive (514) a registration form if (510) this is the first time he/she is registering. Otherwise, the applicant receives (512) an error message stating he/she has already registered or attempted to register. The applicant then fills in and submits (514) the registration from and queried (516) if it is ok to send the phone ID or other unique identifier of the phone. If (516) the applicant is unwilling to send the phone ID, then the applicant will have to (518) use a one-time expiring URL to access the promotion. Otherwise (520), the applicant can use a URL for multiple accesses to the promotion. It is then determined (522) if the registration information is valid (e.g., all information filled in correctly). If (522) the registration is invalid, then the applicant repeats (514) the fill in and submission of the registration form. Otherwise, the applicant receives (524) an email to submit a photo of his/her ID to an email address.

If (526) a photo is not attached to the email, then the applicant receives (528) a no photo message. Otherwise, it is determined (530) if the applicant has signed up, if not, the applicant receives (532) a message stating he/she must sign up first. It is then determined (534) if the applicant is registered. If not, then the applicant receives (536) a message stating he/she must register first. It is then determined (538) if status is pending or resend. If yes, then the applicant must send a new photo since the prior photo was unclear. Receipt of the photo is then confirmed (546) and the applicant waits (548) for operator approval. If (540) status is not approved, then the applicant receives (542) an invalid messages. Otherwise, the applicant receives (544) an approved message and waits (548) for operator approval (or automated approval including ID authentication and applicant verification as described above).

After approval (548), the applicant receives (602) a URL to access the promotion if he/she sent his/her phone ID. The applicant then inputs (604) his/her password and is asked if it is ok to send (606) the phone ID for verification. If it is not, then it is checked (608) if the URL is valid. If not, then the applicant receives (610) an error message. It is ok to send the phone ID, then it is determined (614) if the phone ID and User Agent (unique URL to enter the login page, in which a special code is embedded) is ok. If not, then the applicant receives (612) an error message. Otherwise, it is determined (616) if the password inputted matches the applicant's password. If not, then the applicant receives (618) an error message indicating an invalid password. Otherwise, the applicant accesses (620) the promotion (campaign page).

If the applicant did not send the phone ID during registration, then the applicant clicks (622) on the URL and inputs (624) his/her password. If (626) the User Agent is not ok, then the applicant receives an error message. Otherwise, if (630) the PIN is expired, then the applicant receives (632) a timeout error message and an email is sent (636) with a new URL. If (630) the PIN has not expired, then it is determined (634) if the PIN is valid. If not, the applicant receives (638) an error message. Else, it is determined (640) if the password is ok. If the password doesn't match, then the applicant receives (644) an error message. Otherwise, the applicant then accesses (642) the promotion.

If the applicant without phone ID wants to return to the promotion, then the applicants sends (702) an email to the promotion. If (704) registration is not approved, then the applicant received (706) an email stating awaiting verification. Otherwise, the database is updated (708) with a new PIN and it is transmitted (710) to the applicant so that he/she can access the promotion.

From an operator's perspective, an authorized operator of the system will enter the authorization site. He is asked for his login ID and password. Upon successful entry, he sees (714) a list of pending applications awaiting his review. If he does not see (716) a list, there is nothing to review. If he has a list, he clicks on the first item in the list. The next screen displays (718) the applicants' form and drivers' license images. The operator makes a decision to approve (720), minor (726), invalid (730) or resend (734). The applicant receives the corresponding message approval (722) and access (724) to the campaign page, minor (728), invalid (732) or resend (736).

The foregoing description of the illustrated embodiments of the present invention is by way of example only, and other variations and modifications of the above-described embodiments and methods are possible in light of the foregoing teaching. Although the software are being described as separate and distinct, one skilled in the art will recognize that the software may be a part of an integral site, may each include portions of multiple software, or may include combinations of single and multiple software. Further, components of this invention may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

What is claimed is:

1. A method, comprising:
receiving registration data and an image of an ID from a mobile device of an applicant for an age-restricted promotion;
verifying that the applicant meets an age requirement; and
granting access to the promotion if the applicant meets the age requirement.

2. The method of claim 1, further comprising authenticating the ID.

3. The method of claim 1, wherein the granting access includes transmitting a time-sensitive URL to the applicant.

4. The method of claim 3, wherein the URL includes a key corresponding to the mobile device.

5. The method of claim 4, wherein the key includes an email address of the mobile device.

6. The method of claim 1, wherein the mobile device includes a mobile phone.

7. The method of claim 1, wherein the image of the ID is generated by the mobile device.

8. The method of claim 1, wherein an operator performs the verifying.

9. The method of claim 1, wherein the verifying includes performing optical character recognition on the image of the ID and determining the age of the applicant based on the birth date from the optical character recognition data.

10. A system, comprising:
means for receiving registration data and an image of an ID from a mobile device of an applicant for an age-restricted promotion;
means for verifying that the applicant meets an age requirement; and
means for granting access to the promotion if the applicant meets the age requirement.

11. A system, comprising:
a registration engine capable of receiving registration data and from a mobile device of an applicant for an age-restricted promotion;
a photo engine capable of receiving an image of an ID from the mobile device;
an age engine capable of verifying that the applicant meets an age requirement; and
a promotion engine, communicatively coupled to the age engine, capable of granting access to the promotion if the applicant meets the age requirement.

12. The system of claim 11, further comprising an authentication engine capable of authenticating the ID.

13. The system of claim 11, wherein the granting access includes transmitting a time-sensitive URL to the applicant.

14. The system of claim 13, wherein the URL includes a key corresponding to the mobile device.

15. The system of claim 14, wherein the key includes an email address of the mobile device.

16. The system of claim 11, wherein the mobile device includes a mobile phone.

17. The system of claim 11, wherein the image of the ID is generated by the mobile device.

18. The system of claim 11, wherein the verifying includes performing optical character recognition on the image of the ID and determining the age of the applicant based on the birth date from the optical character recognition data.

19. A computer readable medium having stored thereon instructions to cause a computer to execute a method, the method comprising:
receiving registration data and an image of an ID from a mobile device of an applicant for an age-restricted promotion;
verifying that the applicant meets an age requirement; and
granting access to the promotion if the applicant meets the age requirement.
